(19) United States
(12) Patent Application Publication
(10) Pub. No.: US 2020/0108756 A1
(43) Pub. Date: Apr. 9, 2020

(54) METHOD FOR MANUFACTURING A VEHICLE SEATING SYSTEM

(71) Applicant: LEAR CORPORATION, Southfield, MI (US)

(72) Inventors: Mark DUSO, Grosse Pointe Farms, MI (US); Michael P. MODRESKI, Novi, MI (US); Timothy KRAUSE, Wolverine Lake, MI (US)

(21) Appl. No.: 16/150,305

(22) Filed: Oct. 3, 2018

(51) Int. Cl. B60N 2/70; B29C 44/60; B29C 44/02

(52) U.S. Cl. CPC B60N 2/7017; B60N 2/976; B29C 44/02; B29C 44/60

(57) ABSTRACT

A method for manufacturing a vehicle seating system includes molding a first foam seat part for a first vehicle seating system, which has a first set of seat-related functions. The first foam seat part is molded to include a first identification feature separate from the first set of seat-related functions and is located at a first predetermined location on the first foam seat part. The method also includes detecting the first identification feature with a machine-based system, and assembling the first foam seat part into the first vehicle seating system.

### TECHNICAL FIELD

The present disclosure relates to a method for manufacturing a vehicle seating system.

### BACKGROUND

One of the issues that must be addressed in a complex manufacturing process is ensuring that the desired components are selected and used for the correct assembly. To address this issue, various machine-based automated processes have been implemented. One such process either prints a barcode directly onto a component, or applies to the component an adhesive-backed label containing a barcode. The barcode is then scanned by a machine reader to ensure that the correct component is used in the assembly.

Depending on the size, shape, and material from which the component is manufactured, direct printing of a barcode onto the component, or applying an adhesive label with the barcode, may be difficult or impossible. This may be the situation encountered with molded foam components of the type often used in vehicle seats. The foam material is very often too porous to accept a printed barcode directly onto its surface, and adhesive-backed labels often do not adhere to the surface with enough reliability to be used in an inspection process. Therefore, a need exists for a method for manufacturing a vehicle seating system that addresses some or all of these concerns.

### SUMMARY

Embodiments described herein may include a method for manufacturing a vehicle seating system. Steps in the method may include molding a first foam seat part for a first vehicle seating system having a first set of seat-related functions. The first foam seat part may be molded to include a first identification feature that is separate from the first set of seat-related functions. The first identification feature may be located at a first predetermined location on the first foam seat part. The method may also include detecting the first identification feature with a machine-based system, and assembling the first foam seat part into the first vehicle seating system.

Embodiments described herein may include a method for manufacturing a vehicle seating system that includes the step of molding a first foam seat part for a first vehicle seating system having a first set of seat-related functions. The molding may be performed such that a first identification feature is molded into the first foam seat part, where the first identification feature is separate from the first set of seat-related functions. Steps of the method may also include using a machine-based system to look for the presence of the first identification feature after the first foam part is molded and before the first foam part is assembled into the first vehicle seating system. Other steps may include assembling the first foam seat part into the first vehicle seating system when the machine-based system detects the presence of the first identification feature, and not assembling the first foam seat part into the first vehicle seating system when the machine-based system does not detect the presence of the first identification feature.

Embodiments described herein may include a method for manufacturing a vehicle seating system. Steps in the method may include providing a first mold for molding a first foam seat part for a first vehicle seating system having a first set of seat-related functions. The first mold may be configured to form a first identification feature in the first foam seat part at a first predetermined location, where the first identification feature is separate from the first set of seat-related functions. The method may also include the steps of molding the first foam seat part having the first identification feature in the first mold, and using a machine-based system to look for the presence of the first identification feature after the first foam part is molded and before the first foam part is assembled into the first vehicle seating system. Then the method may include assembling the first foam seat part into the first vehicle seating system when the machine-based system detects the presence of the first identification feature.

### BRIEF DESCRIPTION OF THE DRAWINGS

FIG. 1A shows a vehicle seating system, and more particularly, a foam seat bottom for a driver-side seat configured to accept haptic elements;

FIG. 1B shows vehicle seating system, and more particularly, a foam seat bottom for a passenger-side seat not configured for haptic elements;

FIG. 2A shows a vehicle seating system, and more particularly, a foam seat bottom for a driver-side seat configured to be used without an occupant-sensor pad;

FIG. 2B shows vehicle seating system, and more particularly, a foam seat bottom for a passenger-side seat configured to be used with an occupant-sensor pad;

FIG. 3 shows the foam seat bottom from FIG. 2B partially assembled and undergoing inspection with photoelectric sensors;

FIG. 4 shows a foam seat part being identified through a laser inspection process;

FIG. 5 shows a schematic diagram illustrating a method in accordance with embodiments described herein;

FIG. 6 shows a foam seat part being identified through a laser inspection process;

and

FIG. 7 shows a foam seat part having an identification feature in accordance with embodiments described herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

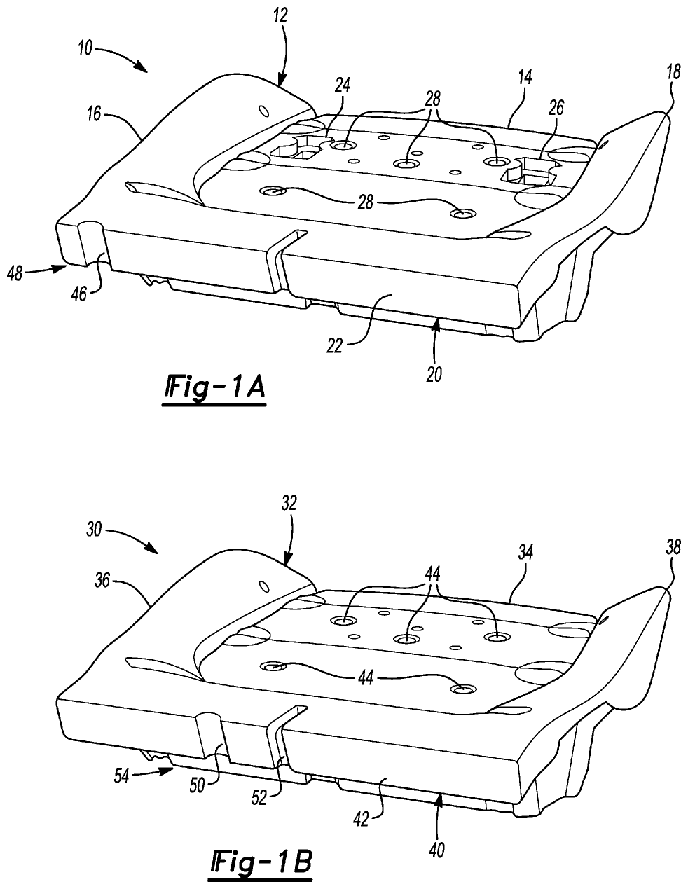

FIG. 1A shows a portion of a first vehicle seating system 10, and in particular, a first foam seat part 12. As shown in FIG. 1A, the foam seat part 12 is configured to be used as part of a seat bottom, although in other embodiments, a foam seat part may be configured for use as a seat back or other portion of the vehicle seating system. The foam seat part 12 includes a main seating portion 14 and side bolsters 16, 18. A rear side 20 of the foam seat part 12 includes a rear edge 22, at least a portion of which will be covered by a seat back when the vehicle seating system 10 is completely assembled. The foam seat part 12 is configured to accept haptic elements, such as massage elements or other functional elements. In particular, openings 24, 26 are molded into the foam seat part 12 to facilitate installation of the haptic elements. Several other openings 28 are also molded into the foam seat part 12, and are part of a ventilation system.

FIG. 1B shows a portion of a second vehicle seating system 30, and in particular, a second foam seat part 32. Similar to the foam seat part 12, the second foam seat part 32 includes a main seating portion 34 and side bolsters 36, 38. The second foam seat part 32 also includes a rear side 40 having a rear edge 42. The second foam seat part 32 also includes a number of molded openings 44 configured to be part of a ventilation system. Therefore, both the first foam seat part 12 and the second foam seat part 32 are ventilated seats, and are both configured to be front seats of the same vehicle. The first foam seat part 12 is, however, intended for use as a driver-side seat and will include the haptic elements—for example, massage elements; whereas, the second foam seat part 32 is intended for use as a passenger-side seat and will not contain the haptic elements. The two foam seat parts 12, 32 are similar in size and shape and may be easy to confuse with one another during a mass-production assembly operation.

In order to help reduce or eliminate the possibility that the foam seat parts 12, 32 will be installed in an incorrect vehicle seating system, embodiments described herein provide a method for manufacturing a vehicle seating system to address this concern. The foam seat parts 12, 32 may be made from any number of different materials, such as polymeric foams, soy- or other natural oil-based foams, or other types of foam materials. These types of foams tend to be porous, so they are not good candidates for printing information directly on their surfaces. Nor are they good candidates for accepting adhesive-backed labels because the labels generally fail to adhere securely to the surfaces. Therefore, common types of identification methods are inappropriate or ineffective for foam seat parts such as the foam seat parts 12, 32.

One method of identification that can be used effectively by a machine-based inspection system—or even by a human operator—is to mold into the foam seat part an identification feature. Molding the identification feature directly into the foam seat part helps to reduce or eliminate errors associated with tagging or other identification methods that are performed on the foam seat part after it is removed from the mold. Molds for a vehicle seat component tend to be large, expensive tools that are made to exacting specifications. Therefore, configuring a mold to mold an identification feature in the molded part is likely to be done accurately, and once having been done, all of the parts manufactured by that mold will be configured with the correct identification feature, thereby reducing or eliminating the opportunity for human error that would otherwise be present in a piece-by-piece process for adding an identification feature in a post-molding process.

One type of identification feature includes a recessed portion or cavity in the foam seat part, while another type of identification feature includes an outwardly-extending portion. Either of these types of identification features may be detectable by a machine-based inspection system, thereby further reducing human error. A recessed portion or cavity may be molded into an edge of the foam seat part, or it may be located on an interior portion of the foam seat part either as a blind hole or a through hole. When a recessed portion or cavity is molded into a foam seat part, it is analogous to removing material from a foam seat part that has already been molded—i.e., the finished part may not appear exactly as specified in an engineering drawing: it has slightly less material in one area. Removing material from a finished part—or using less material than specified—is generally not an acceptable option because it would have a detrimental effect on the part's functionality or appearance. The same may be true when an outwardly-extending identification feature is added to what would otherwise be a finished product. This is one reason that direct printing and adhesive-backed labels are frequently used for identification.

In the embodiments shown in FIGS. 1A and 1B, each of the foam seat parts 12, 32 includes an identification feature, which in this embodiment are recessed portions or cavities molded into their respective rear edges 22, 42. More particularly, the first foam seat part 12 includes a recessed portion or cavity 46 molded inward from the rear side 20 very near the left bolster 16 at a first predetermined location. Similarly, the second foam seat part 32 includes a second recessed portion or cavity 50 that is also molded inward from the rear side 40, but the cavity 50 is much closer to a center 52 of the rear edge 42 than it is to the left side bolster 36. Although the identification features 46, 50 are both positioned along the respective rear edges 22, 42 of the foam seat parts 12, 32, other identification features may be located at other convenient positions on a foam seat part. The rear side may be particularly convenient, however, for an identification feature on a foam seat part that is configured as a vehicle seat bottom. This is because the seat back will at least partially cover the identification feature when the vehicle seat is fully assembled.

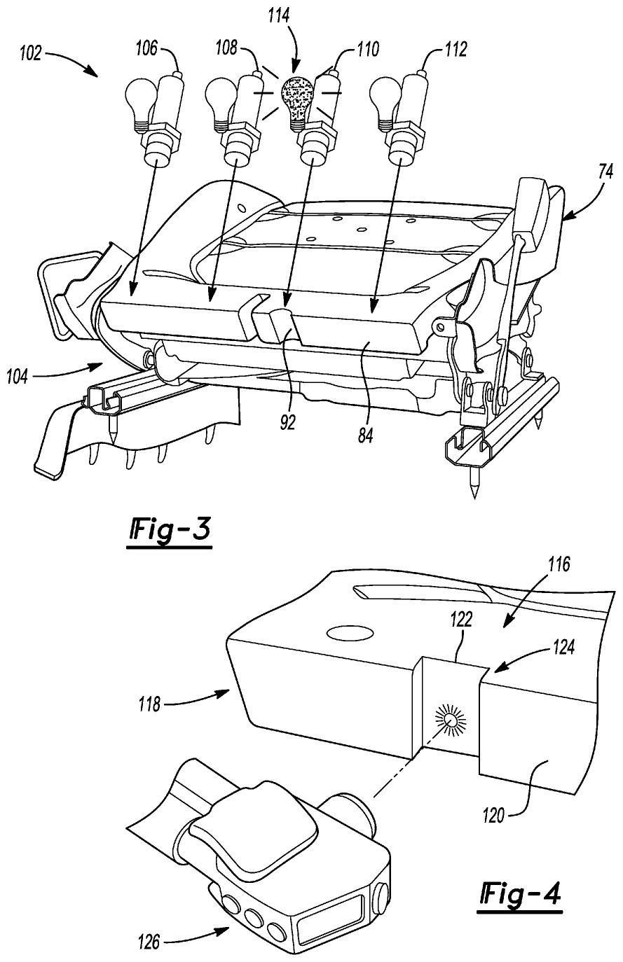

The second recessed portion 50 is positioned at a second predetermined location 54 on the second foam seat part 32 that is different from a corresponding position of the first predetermined location on the first foam seat part 12. As explained in more detail below in conjunction with FIGS. 3 and 4, locating the recessed portions 46, 50 at different locations relative to their respective foam seat parts 12, 32 provides a mechanism for helping to ensure that the first and second foam seat parts 12, 32 are correctly assembled into the respective first and second vehicle seating systems 10, 30.

As described above, the first foam seat part 12 is configured to receive various haptic elements, and is also provided with several ventilation holes 28. The first seating system 10 is therefore designed to have a first set of seat-related functions—in this case haptic elements, such as massagers, and a ventilation system. The first seating system 10 may also have one or more other seat-related functions that make up a part of the first set of seat-related functions, such as, for example, a motorized or manual fore-aft seat adjustment, a reclining seat back, an easy-entry positioning mechanism, an occupant sensor system, or a heater mat, just to name a few. Similarly, the second seating system 30 has a second set of seat-related functions that includes a ventilation system that relies on the ventilation holes 44. Although the second foam seat part 32 does not include haptic elements, it is contemplated that the second seating system 30 will have one or more other seat-related functions in the second set of seat-related functions, such as one or more of the seat-related functions described above in regard to the first seating system 10.

Although one or more of the functions in the first and second sets seat-related functions may overlap, it is contemplated that the first set of seat-related functions will be different from the second set of seat-related functions by at least one function. In the example above, the seating systems 10 and 30 differ at least because the seating system 10 has haptic elements and the seating system 30 does not. This is one of the reasons it is important to make sure that the first and second foam seat parts 12, 32 are assembled into the correct seating system. In at least some cases, a first and second foam seat part, such as the first and second foam seat parts 12, 32, may be configured for the same row of seats in the same vehicle, with one of the foam seat parts configured with functionality designed for the driver-side seat, and the other the foam seat parts configured with functionality designed for the passenger-side seat. In such cases, the size and shape, and even the weight, of the first and second foam seat parts may be very difficult to differentiate.

Because of the potential for assembly error, embodiments described herein provide a method for manufacturing a vehicle seating system that helps to reduce or eliminate this potential for error. In at least some embodiments, both the first and second foam seat parts, include recessed portions or cavities that are separate from their respective seat-related functions. In the examples described above, the first and second foam seat parts 12, 32 include recessed portions or cavities 46, 50 that are separate from their respective seat-related functions. In other words, the cavities 46, 50 are specifically configured to facilitate the inspection process, and are not part of the vehicle seating system functionality.

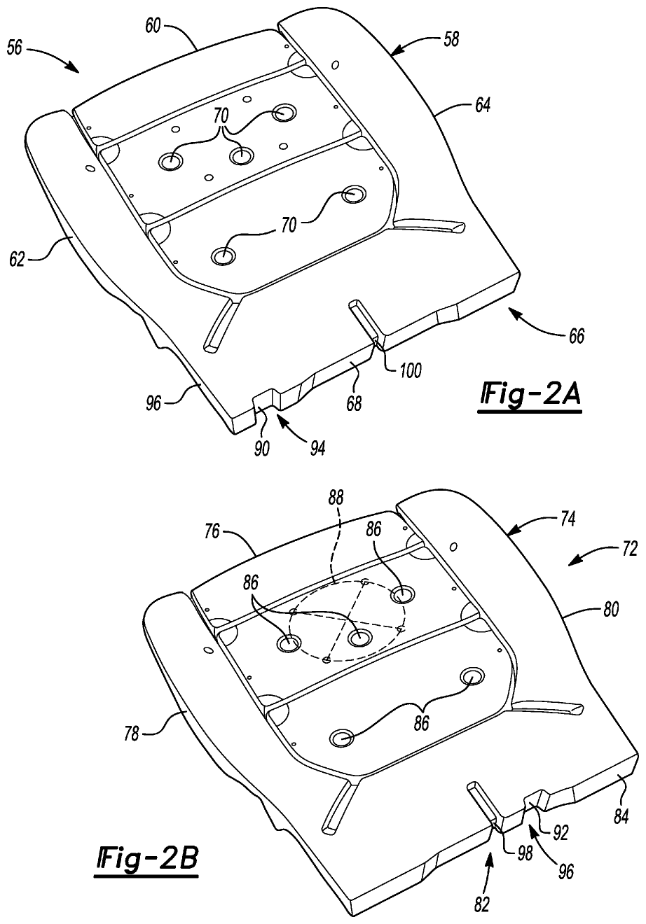

FIGS. 2A and 2B illustrate how embodiments of a method may be applied to another pair of foam seat parts. FIG. 2A shows a portion of a vehicle seating system 56, and in particular, a first foam seat part 58. As shown in FIG. 2A, the foam seat part 58 is configured to be used as part of a seat bottom, although in other embodiments, a foam seat part may be configured for use as a seat back or other portion of the vehicle seating system. The foam seat part 58 includes a main seating portion 60 and side bolsters 62, 64. A rear side 66 of the foam seat part 58 includes a rear edge 68, at least a portion of which will be covered by a seat back when the vehicle seating system 56 is completely assembled. The foam seat part 58 also includes ventilation holes 70 that are part of a ventilation system for the vehicle seating system 56, which is a part of a first set of seat-related functions for the vehicle seating system 56.

FIG. 2B shows a portion of a second vehicle seating system 72, and in particular, a second foam seat part 74. Similar to the foam seat part 58, the second foam seat part 74 includes a main seating portion 76 and side bolsters 78, 80. The second foam seat part 74 also includes a rear side 82 having a rear edge 84. The second foam seat part 74 also includes a number of molded openings 86 configured to be part of a ventilation system. Therefore, both the first foam seat part 58 and the second foam seat part 74 are ventilated seats, and are both configured to be front seats of the same vehicle. The second foam seat part 74 is, however, intended for use as a passenger-side seat and will include an occupant-sensor mat 88, shown in phantom in FIG. 2B. The occupant-sensor mat 88 will form a part of an occupant-sensor system for the second vehicle seating system 72. Conversely, the first foam seat part 58 is intended for use as a driver-side seat and will not contain an occupant-sensor mat or occupant-sensor system.

For the second seating system 72, the ventilation system and the occupant-sensor system are both part of a second set of seat-related functions, and because the first seating system 56 does not include an occupant-sensor system, the first and second sets of seat-related functions are once again different. The two foam seat parts 58, 74 are similar in size and shape and may be easy to confuse with one another during a mass-production assembly operation. Therefore, each of the foam seat parts 58, 74 includes an identification feature molded into it, which in this embodiment is a respective recessed portion or cavity 90, 92 disposed inward from their associated rear edge 68, 84. The cavity 90 in the first foam seat part 58 is disposed at a first predetermined position 94, which in this embodiment, is very near an outer edge 96 of the first foam seat part 58. In contrast, cavity 90 of the second foam seat part 74 is disposed at a second predetermined position 96, which in this embodiment, is very near a center 98 of the rear edge 84. In addition, the cavity 92 is to the right side of the center 98 of the second foam seat part 74; whereas, the cavity 90 is positioned to the left of a center 100 of the first foam seat part 58.

In each case, the cavities 90, 92 are separate from the respective first and second sets of seat-related functions, and as noted above have different locations relative to the sides of their respective foam seat parts 58, 74. As explained in conjunction with FIGS. 3 and 4 these factors will facilitate a machine-based inspection that will help to ensure that the desired foam seat part is assembled in the correct vehicle seating system. FIG. 3 shows a portion of a machine-based system 102 in the process of inspecting the second foam seat part 74. In the embodiment shown in FIG. 3, the foam seat part 74 is assembled to a portion of a seat frame 104. In at least some cases, the frame for a driver-side seat and a passenger-side seat will be the same, so it may be convenient to attach a foam seat part to at least a portion of the seat frame prior to moving it along an assembly line for further inspection.

In the embodiment shown in FIG. 3, the machine-based system 102 used for inspecting the second foam seat part 74 includes a plurality of sensors, which in this embodiment include an array of photoelectric sensors 106, 108, 110, 112. As shown in FIG. 3, the photoelectric sensors 106, 108, 110, 112 are positioned to inspect different portions of the rear edge 84 of the foam seat part 74. More specifically, the photoelectric sensor 110 is positioned to sense an area of the foam seat part 74 that includes the recessed portion 92. As shown in FIG. 3, the photoelectric sensor 110 has detected the presence of the recessed portion 92 and is providing a visual indication 114.

Each of the other photoelectric sensors 106, 108, 112 are positioned to sense an area of the foam seat part 74 away from the recessed portion 92. In addition or as an alternative to a visual indication, a photoelectric sensor may provide an audible or haptic indication, or may output information to another device or system to provide an alert during the assembly process. Although the sensors used in the embodiment shown in FIG. 3 include photoelectric sensors, other types of sensors or other inspection systems may be used, alone or in combination—for example, 3-D scanners, proximity switches, hard fixtures, photo comparisons, or any other type of system effective to detect the identification feature, including a human eye.

Referring back to FIG. 2A, it can be seen that the photoelectric sensor 106 is positioned to sense an area of the foam seat portion 74 that corresponds to the location of the recessed portion 90 in the first foam seat part 58. Therefore, when the first foam seat part 58 is inspected with the machine-based inspection system 102, the photoelectric sensor 106 will detect the presence of the recessed portion 90 and provide a visual indication; the other photoelectric sensors 108, 110, 112 will provide no indication. In the embodiment shown in FIG. 3, the photoelectric sensors 106, 108, 110, 112 are all positioned above the foam seat part 74. In other embodiments, they may be positioned below a foam seat part, and other types of photoelectric sensors rely on two-piece configurations so that one portion of the photoelectric sensor may be above a foam seat part, while another portion of the photoelectric sensor may be positioned below it.

FIG. 4 shows another type of machine-based inspection that can be utilized as part of embodiments for method described herein. FIG. 4 shows a portion of a foam seat part 116 that includes a rear side 118 having a rear edge 120. Molded into the foam seat part 116 is an identification feature 122, which in this embodiment is a recessed portion or cavity 122 positioned inward from the rear edge 120. The cavity 122 is positioned at a predetermined position 124 specifically chosen to provide an identifier for the particular foam seat part 116. In the embodiment illustrated in FIG. 4, a machine-based inspection system, and more particularly, a laser measurement system 126 is used. As described above, embodiments described herein also contemplate the use of other types of inspection systems that are able to at least detect the presence of an identification feature, which may be a recessed portion or cavity in a foam component or a feature extending outwardly from the foam component.

The laser measurement system 126 is positioned at the rear side 118 of the foam seat part 116, and is configured to measure along the rear edge 120 to determine a depth of the recessed portion 122. The measured depth may be relative to the outer surface of the rear edge 120, or some other reference datum may be used. In general, the depth may be measured relative to any convenient reference or references to provide an absolute or relative depth measurement. The laser measurement system 126 can be self-contained, or may be connected to other inspection systems or controllers within the assembly-line operation. When the laser measurement system 126 detects the presence of the recessed portion 120 at the appropriate location 124 along the rear edge 120 it may send this information to another controller, provide a visual, audible, or haptic indication, or some combination of these.

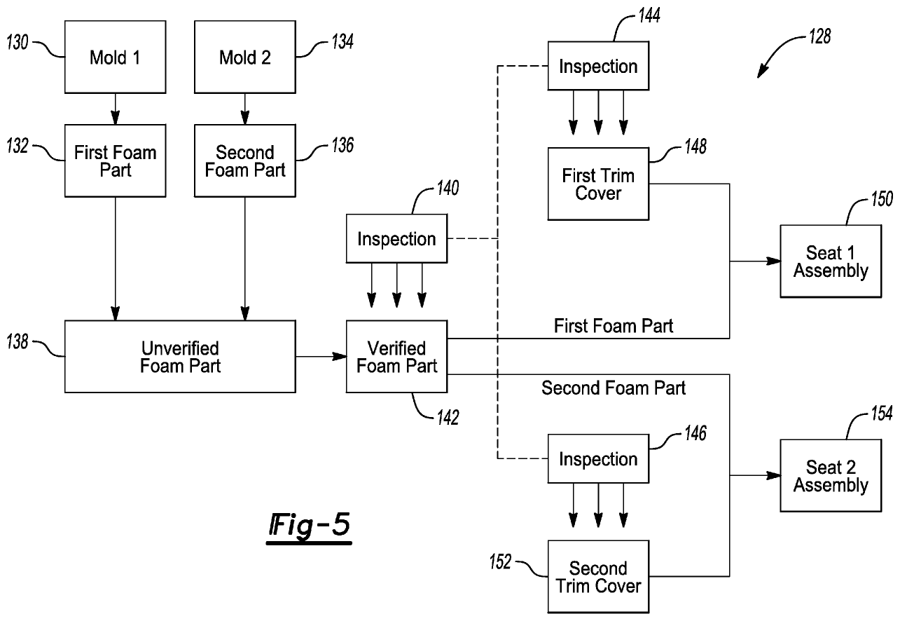

FIG. 5 shows a schematic diagram 128 illustrating an embodiment of a method described herein. At the outset, a first mold 130 is provided for molding a first foam seat part 132 for a first vehicle seating system, such as described above. Similarly, a second mold 134 is provided for molding a second foam seat part 136 as also described above. Although the first and second molds 130, 134 are shown separately and discussed as separate tools, in some embodiments, the first and second molds 130, 134 may comprise the same basic mold pieces with interchangeable elements positioned inside the mold to position the identification features in the proper location on a foam seat part. Although the different foam seat parts may be stored separately and contained within segregated areas, any given foam seat part chosen at random may constitute an unverified foam seat part 138. In accordance with embodiments described herein, an unverified foam seat part may be subject to an inspection, such as by a machine-based inspection system 140. As described above, the inspection system may be a photoelectric sensor system, a laser measurement system, or some other type of inspection system. Once having been inspected, the unverified foam seat part 138 becomes a verified foam seat part 142.

Because a foam seat part is often associated with a particular trim cover, the embodiment illustrated in FIG. 5 contemplates communication between the machine-based inspection system 140, and inspection systems 144, 146 associated with inspecting first and second trim covers, respectively. Unlike foam seat parts, the surface of a trim cover may readily accept an adhesive-backed label; therefore, in at least some embodiments, the inspection systems 144, 146 may include a barcode reader configured to scan a label attached to the surface of the trim cover. If the verified foam seat part 142 is a first foam seat part—for example, identified as having the first recessed portion or cavity, or some other identification feature—and the inspection system 144 identifies a first trim cover 148 that is to be assembled with the first foam seat part, the assembly process is allowed to continue, and the first foam seat part and the first trim cover 148 are assembled as part of a first vehicle seat assembly 150.

Similarly, if the verified foam seat part 142 is a second foam seat part, and the inspection system 146 identifies the trim cover as a second trim cover 152, the process is allowed to continue and the second foam seat part is assembled with the second trim cover 152 as part of a second vehicle seat assembly 154. If, however, there is a mismatch between the foam seat part and the trim cover, communications between the inspection systems 140, 144, 146, can be programmed to stop the assembly process. In this case, the mismatched foam seat part is not assembled into the vehicle seating system, and manual intervention may be required to correct the mismatch.

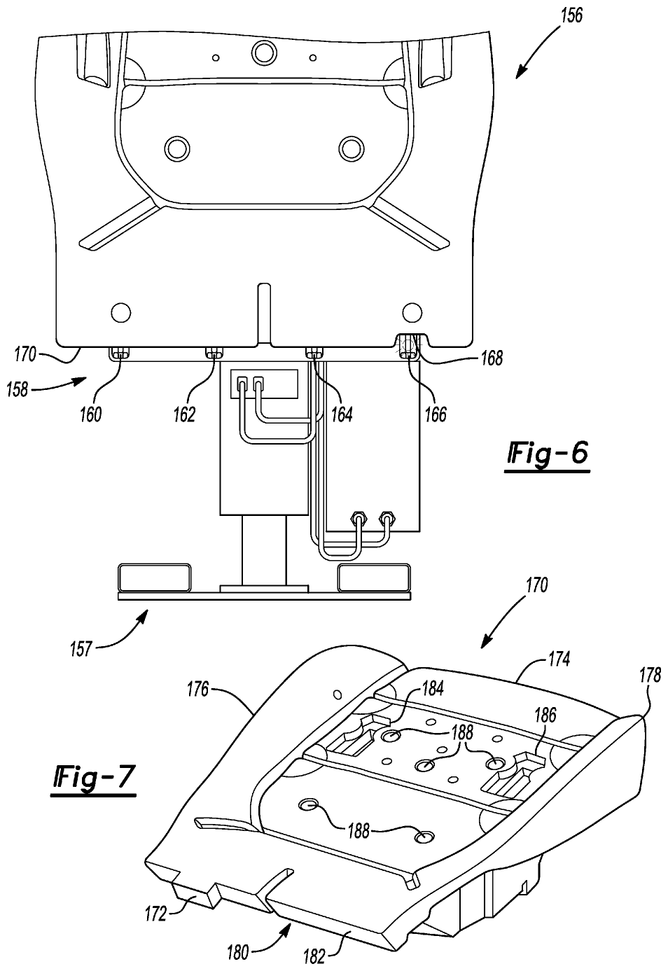

FIG. 6 shows a foam seat part 156 being subject to an inspection process by a machine-based inspection system 157. The inspection system 157 includes a laser sensor array 158, which utilizes laser sensors 160, 162, 164, 166. The foam seat part 156 includes an identification feature 168, which in this embodiment is a recessed portion or cavity molded into a rear edge 170 of the foam seat part 156. As shown in FIG. 6, the laser sensor 166 emits a laser beam that is visible because it is not blocked by the rear edge 170 of the foam seat part 156. Because the cavity 168 is located in the proper position on the foam seat part 156, the laser beam of the laser sensor 166 is uninhibited. Conversely, the other laser sensors 160, 162, 164 have their respective laser beams blocked by the rear edge 170 of the foam seat part 156.

Each of the laser sensors 160, 162, 164, 166 may then communicate with other portions of the inspection system 157 to indicate that the identification feature 168 has been properly detected in the expected location. The inspection system 157 may be part of a larger production system, in which various machine tools, work cells, transfer lines, etc. are interconnected with inspection systems in an integrated manufacturing facility. With a configuration such as this, identification information for a particular foam seat part can be preprogrammed into the production system; then, when information from the various sensors—such as the laser sensors 160, 162, 164, 166—is compared to information about the expected foam seat part, the production process can be allowed to continue if the correct foam seat part is identified, and conversely, the production system may be shut down automatically when an incorrect foam seat part is identified.

As described above, an identification feature can be molded into a foam seat part as a cavity or as an outwardly-extending portion. FIG. 7 shows one example of a foam seat part 170 having an outwardly-extending portion 172 that may be conveniently used as an identification feature in accordance with embodiments described herein. The foam seat part 170 includes a main seating portion 174 and side bolsters 176, 178. A rear side 180 of the foam seat part 170 includes a rear edge 182, at least a portion of which will be covered by a seat back when the associated vehicle seating system is completely assembled. The foam seat part 170 is configured to accept haptic elements, such as massage elements or other functional elements. In particular, openings 184, 186 are molded into the foam seat part 170 to facilitate installation of the haptic elements. Several other openings 188 are also molded into the foam seat part 170, and are part of a ventilation system.

In the embodiment shown in FIG. 7, the identification feature 172 extends outwardly from the foam seat part 170 along the rear edge 182. In this type of configuration, inspection systems such as those described above may still be effectively utilized. For example, the photosensor system 102 shown in FIG. 3 may be programmed to identify the presence of material, rather than the absence of material such as described above. It may then communicate this information by alerting the operator, it may communicate the information to a larger production system that is programmed to take a particular action depending on the information received, or it may do some combination of these.

Similarly, the laser sensor array 158 may also be configured to identify a foam seat part based on one laser beam being blocked while the light emitted from the other lasers is uninhibited. Although the identification feature 172 is illustrated as a rectangular solid emanating from the rear edge 182 of the foam seat part 170, other configurations of and locations for an outwardly-extending identification feature are contemplated. Such features may extend from a side of the foam seat part or upward or downward from the upper or lower surface, respectively. As described in detail, embodiments described herein may be used effectively to help ensure the proper assembly and positioning of complex seating elements within a vehicle seating system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for manufacturing a vehicle seating system, comprising:
molding a first foam seat part for a first vehicle seating system having a first set of seat-related functions such that a first identification feature is molded into the first foam seat part separate from the first set of seat-related functions;
using a machine-based system to look for the presence of the first identification feature after the first foam part is molded and before the first foam part is assembled into the first vehicle seating system;
assembling the first foam seat part into the first vehicle seating system when the machine-based system detects the presence of the first identification feature; and
not assembling the first foam seat part into the first vehicle seating system when the machine-based system does not detect the presence of the first identification feature.

2. The method of claim 1, wherein using the machine-based system to look for the presence of the first identification feature includes using at least one sensor positioned at least one of above or below the first foam seat part.

3. The method of claim 1, further comprising:
molding a second foam seat part for a second vehicle seating system having a second set of seat-related functions different from the first set of seat-related functions, such that a second identification feature is molded into the second foam seat part separate from the second set of seat-related functions, the second identification feature being located on the second foam seat part at a position that is different from a location of the first identification feature on the first foam seat part;
using the machine-based system to look for the presence of the second identification feature after the second foam part is molded and for the second foam part is assembled into the second vehicle seating system;
assembling the second foam seat part into the second vehicle seating system when the machine-based system detects the presence of the second identification feature; and
not assembling the second foam seat part into the second vehicle seating system when the machine-based system does not detect the presence of the second identification feature.

4. The method of claim 3, wherein the first identification feature includes a first cavity molded inward from a side of the first foam seat part, and the second identification feature includes a second cavity molded inward from a side of the second foam seat part.

5. A method for manufacturing a vehicle seating system, comprising:
molding a first foam seat part for a first vehicle seating system having a first set of seat-related functions, the first foam seat part being molded to include a first identification feature separate from the first set of seat-related functions, the first identification feature being located at a first predetermined location on the first foam seat part;
detecting the first identification feature with a machine-based system; and
assembling the first foam seat part into the first vehicle seating system.

6. The method of claim 5, further comprising:
molding a second foam seat part for a second vehicle seating system having a second set of seat-related functions different from the first set of seat-related functions, the second foam seat part being molded to include a second identification feature separate from the second set of seat-related functions, the second identification feature being positioned at a second predetermined location on the second foam seat part that is different from a corresponding position of the first predetermined location on the first foam seat part;
detecting the second identification feature with the machine-based system; and
assembling the second foam seat part into the second vehicle seating system.

7. The method of claim 6, wherein detecting the first identification feature with the machine-based system includes using a plurality of sensors positioned at different locations relative to the first foam seat part, at least one of the sensors being positioned to sense an area of the first foam seat part including the first identification feature, and at least one other of the sensors being positioned to sense an area of the first foam seat part not including the first identification feature.

8. The method of claim 7, wherein at least one of the at least one other sensors is positioned to sense an area of the second foam seat part including the second identification feature.

9. The method of claim 8, wherein the first foam seat part is a foam seat part for a seat bottom of the first vehicle seating system, and the first identification feature forms a first recessed portion inward from a rear edge of the first foam seat part, and
the second foam seat part is a foam seat part for a seat bottom of the second vehicle seating system, and the second identification feature forms a second recessed portion inward from a rear edge of the second foam seat part.

10. The method of claim 8, wherein the first identification feature extends outwardly from the first foam seat part.

11. The method of claim 5, wherein the first foam seat part is a foam seat part for a seat bottom, and the first identification feature is positioned along a rear edge of the first foam seat part.

12. The method of claim 11, wherein detecting the first identification feature with the machine-based system includes using at least one of a photoelectric sensor array or a laser sensor array positioned proximate to the rear edge of the first foam seat part.

13. A method for manufacturing a vehicle seating system, comprising:
providing a first mold for molding a first foam seat part for a first vehicle seating system having a first set of seat-related functions, the first mold being configured to form a first identification feature in the first foam seat part at a first predetermined location, the first identification feature being separate from the first set of seat-related functions;
molding the first foam seat part having the first identification feature in the first mold;
using a machine-based system to look for the presence of the first identification feature after the first foam part is molded and before the first foam part is assembled into the first vehicle seating system; and
assembling the first foam seat part into the first vehicle seating system when the machine-based system detects the presence of the first identification feature.

14. The method of claim 13, further comprising:
providing a second mold for molding a second foam seat part for a second vehicle seating system having a second set of seat-related functions different from the first set of seat-related functions, the second mold being configured to form a second identification feature in the second foam seat part at a second predetermined location that is different from a corresponding position of the first predetermined location on the first foam seat part, the second identification feature being separate from the second set of seat-related functions;
molding the second foam seat part having the second identification feature in the second mold;
using a machine-based system to look for the presence of the second identification feature after the second foam part is molded and before the second foam part is assembled into the second vehicle seating system; and
assembling the second foam seat part into the second vehicle seating system when the machine-based system detects the presence of the second identification feature.

15. The method of claim 14, further comprising modifying the first mold to create the second mold.

16. The method of claim 14, wherein using a machine-based system to look for the presence of the first identification feature includes using a plurality of sensors positioned at different locations relative to the first foam seat part, at least one of the sensors being positioned to sense an area of the first foam seat part including the first identification feature, and at least one other of the sensors being positioned to sense an area of the first foam seat part not including the first identification feature.

17. The method of claim 16, wherein at least one of the at least one other sensors is positioned to sense an area of the second foam seat part including the second identification feature.

18. The method of claim 17, wherein the first foam seat part is a foam seat part for a seat bottom of the first vehicle seating system, and the first identification feature is positioned along a rear edge of the first foam seat part, and
the second foam seat part is a foam seat part for a seat bottom of the second vehicle seating system, and the second identification feature is positioned along a rear edge of the second foam seat part.

19. The method of claim 13, wherein the first foam seat part is a foam seat part for a seat bottom, and the first identification feature includes a first cavity is positioned along a rear edge of the first foam seat part.

20. The method of claim 19, wherein using a machine-based system to look for the presence of the first cavity includes using at least one of a photoelectric sensor array or a laser sensor array positioned proximate to the rear edge of the first foam seat part.
